(19) United States
(12) Patent Application Publication
(10) Pub. No.: US 2020/0101602 A1
(43) Pub. Date: Apr. 2, 2020

(54) FOOD HOLDING APPARATUS AND METHOD OF OPERATING SAME

(71) Applicant: KAWASAKI JUKOGYO KABUSHIKI KAISHA, Kobe-shi, Hyogo (JP)

(72) Inventors: Kenji BANDO, Nishinomiya-shi (JP); Kazunori HIRATA, Yao-shi (JP)

(73) Assignee: KAWASAKI JUKOGYO KABUSHIKI KAISHA, Kobe-shi, Hyogo (JP)

(21) Appl. No.: 16/500,564

(22) PCT Filed: Apr. 2, 2018
(86) PCT No.: PCT/JP2018/014071

§ 371 Date: Oct. 3, 2019

(30) Foreign Application Priority Data
Apr. 3, 2017 (JP) 2017-073834

(51) Int. Cl. B25J 9/16; B25J 9/00; B25J 11/00; B25J 15/02

(52) U.S. Cl. CPC B25J 9/1612; B25J 15/0253; B25J 11/0045; B25J 9/0093

(57) ABSTRACT

A food holding apparatus includes: a base portion; a holding portion at the base portion and configured to hold a side portion of the food; a placing portion at the base portion, the food being placed on the placing portion; and a control portion configured to control a movement of the holding portion and a movement of the placing portion. With the side portion of the food held by the holding portion, the control portion controls at least one of the movement of the holding portion relative to the base portion and the movement of the placing portion relative to the base portion to place the food on the placing portion.

### TECHNICAL FIELD

The present invention relates to a food holding apparatus and a method of operating the food holding apparatus.

### BACKGROUND ART

At manufacturing sites for foods, such as in-flight meals and box lunches, work of dishing up foods is being performed by workers. Each worker picks up with one hand a food container conveyed by a conveyor. While maintaining a predetermined posture of the food container, the worker sprinkles seasoning on a food in the container with the other hand. After that, the worker releases the food to a predetermined position on the conveyor.

In recent years, from the viewpoint of productivity improvement, proposed in various fields is that a robot and a worker perform work in the same work space in cooperation with each other. When a human-shaped working robot is introduced to the above manufacturing site for the food and performs work of dishing up the food, measures to surely hold the food and maintain the predetermined posture of the food are required. PTL 1 discloses an end effector including: a suction pad configured to suction and hold a side surface of a box-shaped object; an advancing-retreating mechanism configured to make the suction pad advance and retreat; and a placing member on which the object suctioned and pulled out is placed. PTL 2 discloses a robot hand configured to surely hold a food. This robot hand suctions an object by a suction nozzle and pulls the object by a nozzle mechanism to a position at which finger forming bodies can grasp the object. Then, the robot hand supports the object by inner sides of the finger forming bodies.

### CITATION LIST

### Patent Literature

PTL 1: Japanese Laid-Open Patent Application Publication No. 2014-210316

PTL 2: Japanese Laid-Open Patent Application Publication No. 9-38882

### SUMMARY OF INVENTION

### Technical Problem

However, the end effector of PTL 1 is configured to carry out large cargos loaded on containers. Therefore, the end effector of PTL1 is not suitable for holding a food conveyed on a conveyor at a manufacturing site for the food. Further, the robot hand of PTL 2 is configured to suction and hold an upper portion of the object. Therefore, if the robot hand of PTL 2 holds a food, the suction nozzle is located above the food. On this account, when the robot hand of PTL 2 holds the food, it is difficult to supply seasoning from above the food.

The present invention was made to solve the above problems, and an object of the present invention is to surely hold a food, such as an in-flight meal or a box lunch, at a manufacturing site for the food.

### Solution to Problem

To achieve the above object, a food holding apparatus according to an aspect of the present invention is a food holding apparatus configured to hold a food. The food holding apparatus includes: a base portion; a holding portion provided at the base portion and configured to hold a side portion of the food; a placing portion provided at the base portion, the food being placed on the placing portion; and a control portion configured to control a movement of the holding portion and a movement of the placing portion. With the side portion of the food held by the holding portion, the control portion controls at least one of the movement of the holding portion relative to the base portion and the movement of the placing portion relative to the base portion to place the food on the placing portion.

According to the above configuration, the food is placed on the placing portion with the side surface of the food held by the holding portion. Therefore, the food, such as an in-flight meal or a box lunch, can be surely held. Further, since a space above the food is secured, predetermined work (spreading of sauce, for example) with respect to the food is easily performed.

The holding portion may be configured to be movable in a direction toward the base portion and a direction opposite to the direction toward the base portion. The control portion may make the holding portion hold the side portion of the food arranged at a predetermined position. With the side portion of the food held by the holding portion, the control portion may make the holding portion move in the direction toward the base portion to place the food on the placing portion.

According to the above configuration, with the food held by the holding portion, the holding portion is moved in the direction toward the base portion. Therefore, the food is easily placed on the placing portion.

The placing portion may be configured to be movable in a direction toward the base portion and a direction opposite to the direction toward the base portion. The control portion may make the holding portion hold the side portion of the food arranged at a predetermined position. With the side portion of the food held by the holding portion, the control portion may make the placing portion move relative to the base portion in a direction toward the food to place the food on the placing portion.

According to the above configuration, with the food held by the holding portion, the placing portion is moved in the direction toward the holding portion. Therefore, the movement distance of the food can be made short. Thus, the state of the content in the food container is easily kept.

With the side portion of the food held by the holding portion and with the food placed on the placing portion, the control portion may control at least one of the movement of the holding portion relative to the base portion and the movement of the placing portion relative to the base portion to release the food to a predetermined position. According to the above configuration, for example, the food can be released onto the conveyor after the food is subjected to sauce spreading work.

The predetermined position may be a position between a pair of regulating members provided on a conveyor so as to be opposed to each other. An interval between the pair of regulating members may be slightly larger than a width of the food.

According to the above configuration, the interval between the pair of control members provided on the conveyor so as to be opposed to each other is slightly larger than the width of the food. Therefore, the positioning of the holding portion is only required to be performed regarding a position in the conveying direction of the conveyor relative to the food arranged between the control members.

The holding portion may be configured to be movable in an upper-lower direction while holding the side portion of the food. With the side portion of the food held by the holding portion, the control portion may make the holding portion slightly lift the food upward and then control at least one of the movement of the holding portion relative to the base portion and the movement of the placing portion relative to the base portion.

According to the above configuration, with the food held, the food is slightly lifted upward. Therefore, the food is easily placed on the placing portion.

A method of operating a food holding apparatus according to another aspect of the present invention is a method of operating a food holding apparatus, the food holding apparatus including: a base portion; a holding portion provided at the base portion and configured to hold a side surface of a food; a placing portion provided at the base portion, the food being placed on the placing portion; and a control portion configured to control a movement of the holding portion and a movement of the placing portion. The method includes, with the side surface of the food held by the holding portion, controlling at least one of the movement of the holding portion relative to the base portion and the movement of the placing portion relative to the base portion to place the food on the placing portion.

### Advantageous Effects of Invention

The present invention is configured as above and can surely hold a food, such as an in-flight meal or a box lunch, at a manufacturing site for the food.

### BRIEF DESCRIPTION OF DRAWINGS

FIG. 1 is a perspective view showing an entire configuration of a robot according to one embodiment of the present invention.

FIG. 2 is a front view schematically showing an entire configuration of one example of the robot of FIG. 1.

FIGS. 3A and 3B are diagrams each showing the configuration of an end effector of a left arm of FIG. 2.

FIGS. 4A and 4B are diagrams each showing the configuration of an end effector of a right arm of FIG. 2.

FIG. 5 is a functional block diagram schematically showing the configuration of a controller.

FIG. 6 is a flow chart showing a procedure of driving of the robot.

FIGS. 7A and 7B are schematic diagrams each showing one example of an operation (food holding) of the robot.

FIGS. 8A and 8B are schematic diagrams each showing one example of an operation (work) of the robot.

FIG. 9 is a schematic diagram showing one example of the operation (work) of the robot.

FIGS. 10A and 10B are schematic diagrams each showing one example of the operation (food releasing) of the robot.

FIGS. 11A and 11B are schematic diagrams each showing another example of the operation (food holding) of the robot.

FIGS. 12A to 12C are schematic diagrams each showing yet another example of the operation (food holding) of the robot.

### DESCRIPTION OF EMBODIMENTS

Hereinafter, a preferred embodiment will be described with reference to the drawings. In the following description and the drawings, the same reference signs are used for the same or corresponding components, and a repetition of the same explanation is avoided. Further, for ease of understanding, components are schematically shown in the drawings.

### Embodiment

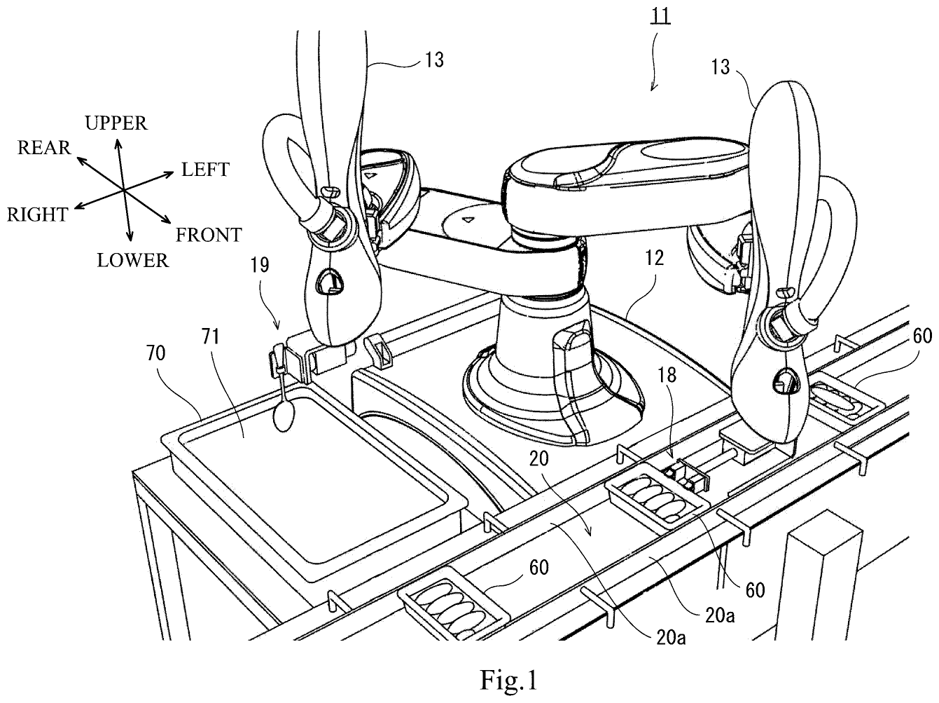

FIG. 1 is a perspective view showing an entire configuration of the robot according to one embodiment of the present invention. Hereinafter, a direction in which a pair of arms are spread is referred to as a left-right direction. A direction parallel to a center axis of a base shaft is referred to as an upper-lower direction. A direction perpendicular to the left-right direction and the upper-lower direction is referred to as a front-rear direction. A robot 11 is introduced to a manufacturing site for foods 60. In the present embodiment, each food 60 is an in-flight meal put in a predetermined container. Hereinafter, a food container and its content are collectively called the food 60. The food container has such a shape that a top portion thereof is open, and a bottom portion thereof is closed. One example of the food content is a pork cutlet. The robot 11 is an apparatus configured to perform work of dishing up the food 60.

As shown in FIG. 1, the robot 11 is a double-arm robot including a pair of robot arms (hereinafter simply referred to as “arms”) 13 supported by a base 12. The robot 11 can be set up in a limited space (for example, 610 mm×620 mm) corresponding to a space for one person. A large tray container 70 is arranged on the right side of the robot 11. The tray container 70 has such a shape that a top portion thereof is open, and a bottom portion thereof is closed. An ingredient 71 having fluidity is stored in the tray container 70. In the present embodiment, the ingredient 71 having the fluidity is sauce for pork cutlets. A conveyor 20 configured to convey the foods 60 in a predetermined direction (a direction from the right side toward the left side in the drawings) is arranged in front of the robot 11. A pair of regulating members 20a are provided at both respective sides of the conveyor 20 along the conveying direction so as to be opposed to each other. Each of the regulating members 20a is formed in a flat plate shape. Each of inner walls of the regulating members 20a has a flat surface parallel to the conveying direction. The food 60 on the conveyor 20 is arranged between the pair of regulating members 20a. The robot 11 holds the food 60 on the conveyor 20 by an end effector 18 coupled to the left arm 13 and supplies the sauce (71) onto the food 60 by an end effector 19 coupled to the right arm 13. In the present embodiment, a work region of the pair of robot arms 13 is a region partially covering the tray container 70 arranged at the right side of the robot 11 and the conveyor 20 arranged in front of the robot 11.

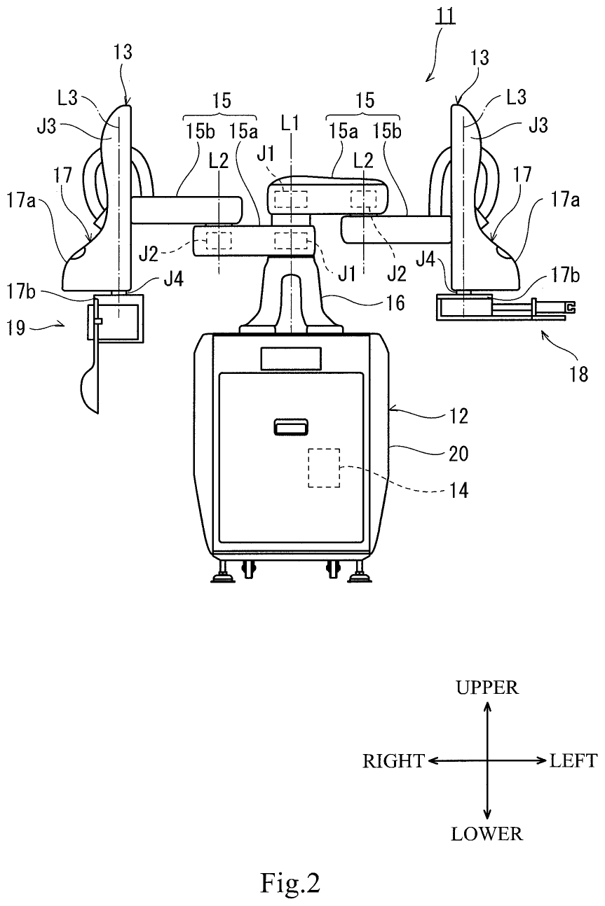

FIG. 2 is a front view schematically showing an entire configuration of one example of the robot 11. As shown in FIG. 2, the robot 11 includes: the base 12 fixed to a cart; the pair of robot arms 13 supported by the base 12; and a controller 14 accommodated in the base 12. Each of the arms 13 is a horizontal articulated robot arm configured to be movable relative to the base 12. Each of the arms 13 includes an arm portion 15, a wrist portion 17, and the end effector 18 or 19. It should be noted that the right arm 13 and the left arm 13 may be substantially the same in structure as each other. Further, the right arm 13 and the left arm 13 can operate independently and can also operate in association with each other.

In the present embodiment, the arm portion 15 is constituted by a first link 15a and a second link 15b. The first link 15a is coupled to a base shaft 16 by a rotational joint J1, the base shaft 16 being fixed to an upper surface of the base 12. The first link 15a is rotatable about a rotation axis L1 extending through a center axis of the base shaft 16. The second link 15b is coupled to a tip end of the first link 15a by a rotational joint J2. The second link 15b is rotatable about a rotation axis L2 defined at the tip end of the first link 15a.

The wrist portion 17 is constituted by an up/down portion 17a and a rotary portion 17b. The up/down portion 17a is coupled to a tip end of the second link 15b by a linear motion joint J3 and can move up and down relative to the second link 15b. The rotary portion 17b is coupled to a lower end of the up/down portion 17a by a rotational joint J4. The rotary portion 17b is rotatable about a rotation axis L3 defined at the lower end of the up/down portion 17a. The end effectors 18 and 19 are coupled to the respective rotary portions 17b of the left and right wrist portions 17. To be specific, the end effectors 18 and 19 are provided at respective tip ends of the left and right arms 13.

Each arm 13 configured as above includes the joints J1 to J4. Servomotors for driving (not shown), encoders (not shown) configured to detect rotation angles of the servomotors, and the like are provided at the arm 13 so as to correspond to the joints J1 to J4. Further, the rotation axes L1 of the first links 15a of the two arms 13 are located on the same straight line. The first link 15a of one of the arm 13 and the first link 15a of the other arm 13 are arranged with a height difference therebetween in the upper-lower direction.

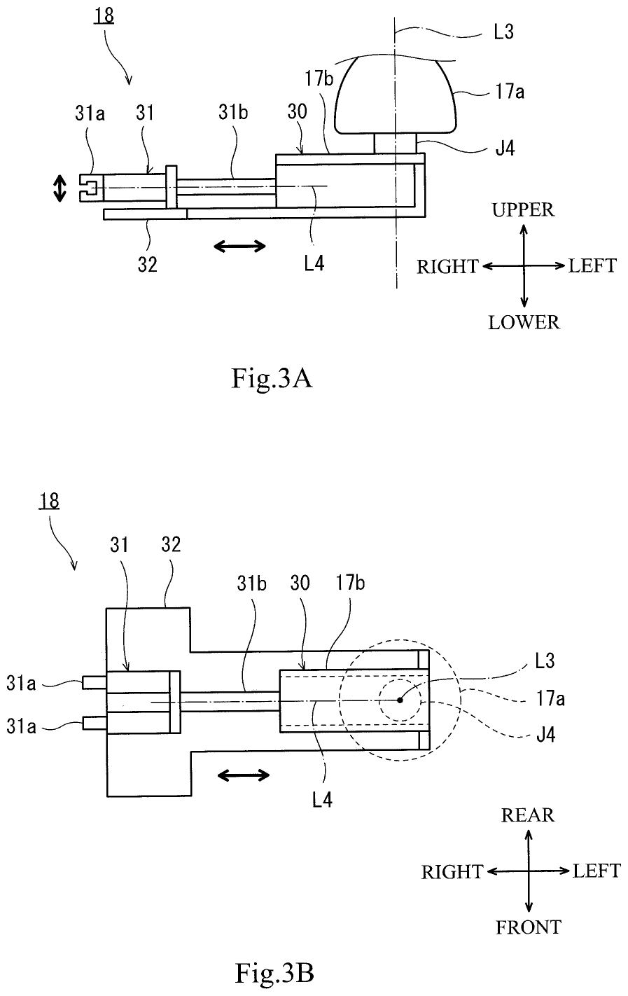

FIG. 3A is a side view showing the configuration of the end effector 18 provided at the left arm 13. FIG. 3B is a plan view showing the configuration of the end effector 18 provided at the left arm 13. The end effector 18 is configured to hold the food 60. The end effector 18 includes: a base portion 30 including the rotary portion 17b of the wrist portion 17; two holding portions 31 provided at the base portion 30; and a placing portion 32 provided at the base portion 30.

The base portion 30 includes a linear motion shaft 31b having a tip end to which the holding portions 31 are attached. The base portion 30 also includes therein an actuator (not shown) configured to drive the linear motion shaft 31b along a central axis (L4). When the actuator drives the linear motion shaft 31b, the holding portions 31 can move in a predetermined direction (the left-right direction in the drawings) relative to the base portion 30. With this, the holding portions 31 can move in a direction toward the base portion 30 and a direction opposite to the direction toward the base portion 30.

Each of the holding portions 31 includes a pair of jaw portions 31a provided at a tip end thereof and also includes therein an actuator (not shown) configured to drive the jaw portions 31a. The actuator can change an interval between the pair of jaw portions 31a (in the upper-lower direction in the drawings), and with this, the pair of jaw portions 31a can hold a side portion 60a of the food 60.

The placing portion 32 has a flat plate shape curved in an L shape in a side view and is arranged on the lower side of the base portion 30 and the holding portions 31. In the present embodiment, the placing portion 32 is fixed to the base portion 30. To place the food 60, a tip end of the placing portion 32 is formed in a rectangular shape in a plan view so as to correspond to the size of the food 60.

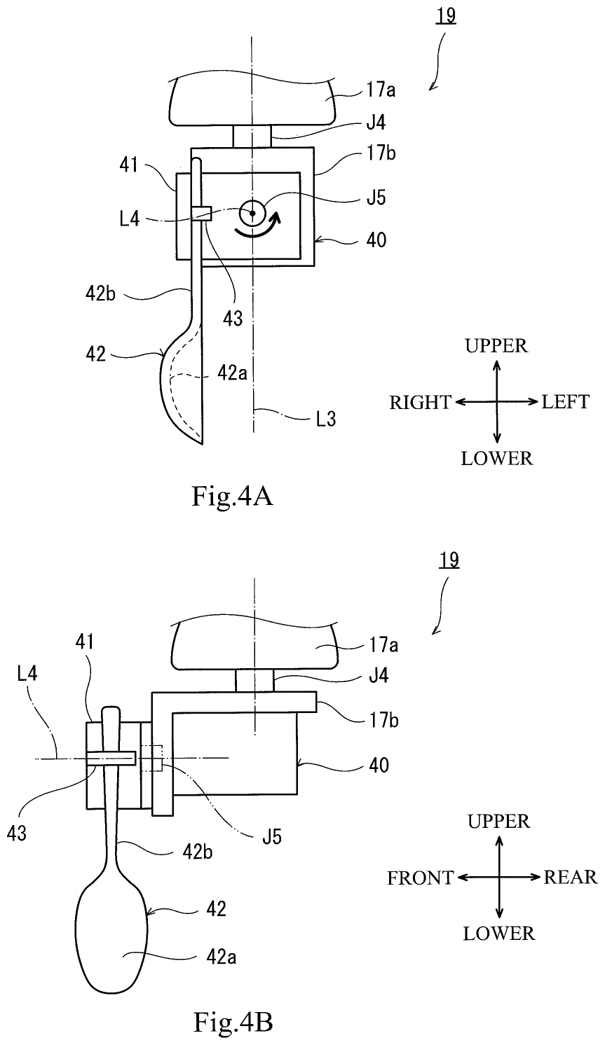

FIG. 4A is a front view showing the configuration of the end effector 19 provided at the right arm 13. FIG. 4B is a side view showing the configuration of the end effector 19 provided at the right arm 13. The end effector 19 is configured to hold the ingredient 71 having fluidity and release the ingredient 71 to the food 60. The end effector 19 includes: a base portion 40 including the rotary portion 17b of the wrist portion 17; a rotational joint J5 having a rotation axis L4 parallel to a horizontal direction (the front-rear direction in the drawings) in at least one of postures of the robot arm 13; a rotary portion 41 rotatably coupled to the base portion 40 by the rotational joint J5; and a tip end portion 42 attached to the rotary portion 41.

The base portion 40 is coupled to the up/down portion 17a of the wrist portion 17 through the rotational joint J4 and also coupled to the rotary portion 41 through the rotational joint J5. The base portion 40 is bent in a substantially L shape in a side view and includes therein a driving portion for the rotational joint J5.

The rotary portion 41 is coupled to the base portion 40 through the rotational joint J5. The tip end portion 42 is attached to the rotary portion 41 through an attachment member 43. The tip end portion 42 includes a concave portion 42a and a handle portion 42b. In the present embodiment, the tip end portion 42 has a spoon shape. The handle portion 42b of the spoon is fixed to the rotary portion 41 through the attachment member 43. In FIGS. 4A and 4B, a longitudinal direction of the spoon is substantially parallel to a vertical direction. The concave portion 42a of the spoon is located on the lower side, and the handle portion 42b of the spoon is located on the upper side. The concave portion 42a faces in the horizontal direction. Hereinafter, a state where the concave portion 42a of the tip end portion 42 is located on the lower side and faces in the horizontal direction as shown in FIGS. 4A and 4B is referred to as a reference state of the tip end portion 42.

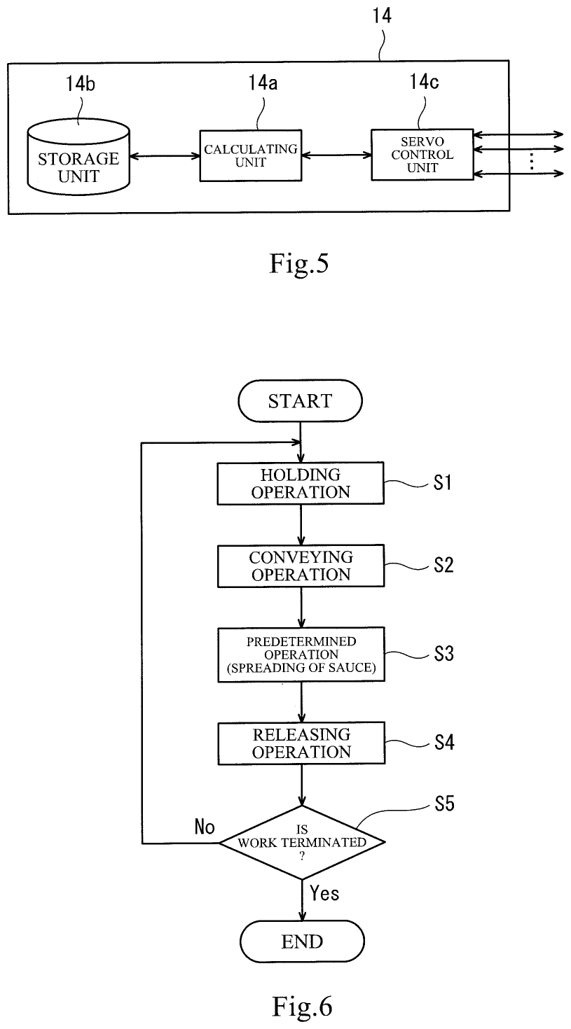

FIG. 5 is a functional block diagram schematically showing the configuration of the controller 14 (see FIG. 2) of the robot 11. As shown in FIG. 5, the controller 14 includes: a calculating unit 14a, such as a CPU; a storage unit 14b, such as a ROM and a RAM; and a servo control unit 14c. The controller 14 is a robot controller including a computer, such as a microcontroller. It should be noted that the controller 14 may be constituted by a single controller 14 configured to perform centralized control or may be constituted by a plurality of controllers 14 which cooperate to perform distributed control.

The storage unit 14b stores a basic program of the robot controller and information, such as various fixed data. The calculating unit 14a controls various operations of the robot 11 by reading and executing software, such as the basic program, stored in the storage unit 14b. To be specific, the calculating unit 14a generates a control command of the robot 11 and outputs the control command to the servo control unit 14c. Based on the control command generated by the calculating unit 14a, the servo control unit 14c controls the driving of the servomotors corresponding to the joints J1 to J4 of the arms 13 of the robot 11. Further, the controller 6 also controls the operation of holding the food 60 by the end effector 18 and the operation of supplying the sauce (71) by the end effector 19. Thus, the controller 6 controls the operations of the entire robot 11.

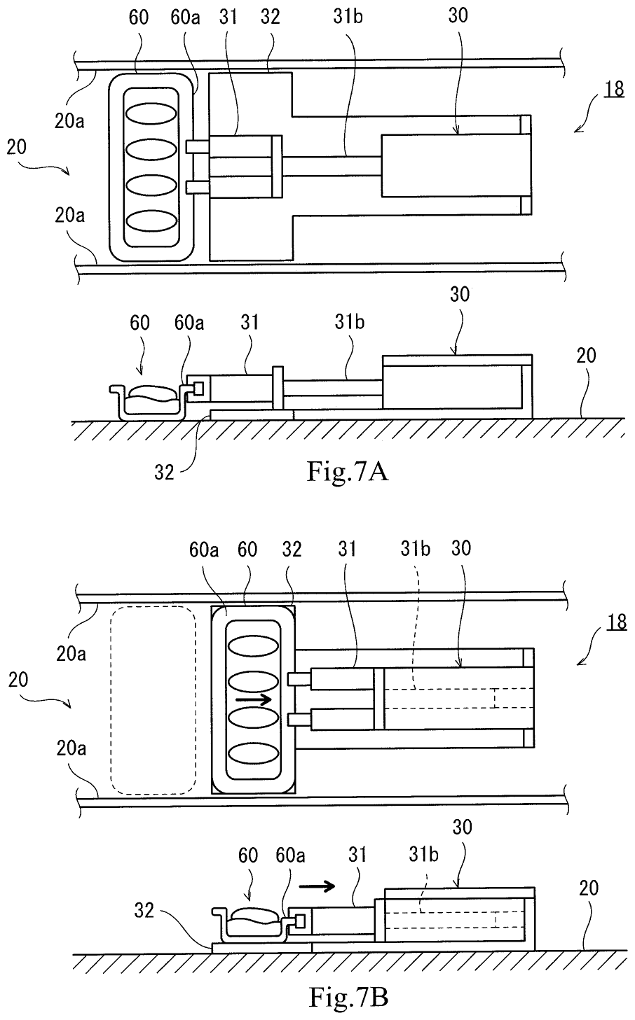

Next, one example of driving operations of the robot 11 controlled by the controller 14 will be described by using a flow chart in FIG. 6. FIGS. 7A to 10B are schematic diagrams each showing one example of the operations of the robot 11.

First, the robot 11 holds the food 60 on the conveyor 20 by the end effector 18 (see Step 51 in FIG. 6). In the present embodiment, the controller 14 controls the operation of the left arm 13 to position the end effector 18 at a predetermined position on the conveyor 20 as shown in FIG. 7A. The side portion 60a of the food 60 arranged at a predetermined position is held by the holding portions 31 of the end effector 18. Herein, the predetermined position denotes a position between the pair of regulating members 20a provided on the conveyor 20 so as to be opposed to each other. Herein, an interval between the regulating members 20a has a distance slightly longer than the width of the food 60. With this, the positioning of the holding portions 31 at the time of the holding operation is only required to be performed regarding a position in the conveying direction of the conveyor 20 with respect to the food 60 arranged between the regulating members 20a. Then, as shown in FIG. 7B, the side portion 60a of the food 60 is held by the holding portions 31 of the end effector 18, and the holding portions 31 are moved in the direction toward the base portion 30. With this, the food 60 is placed on the placing portion 32.

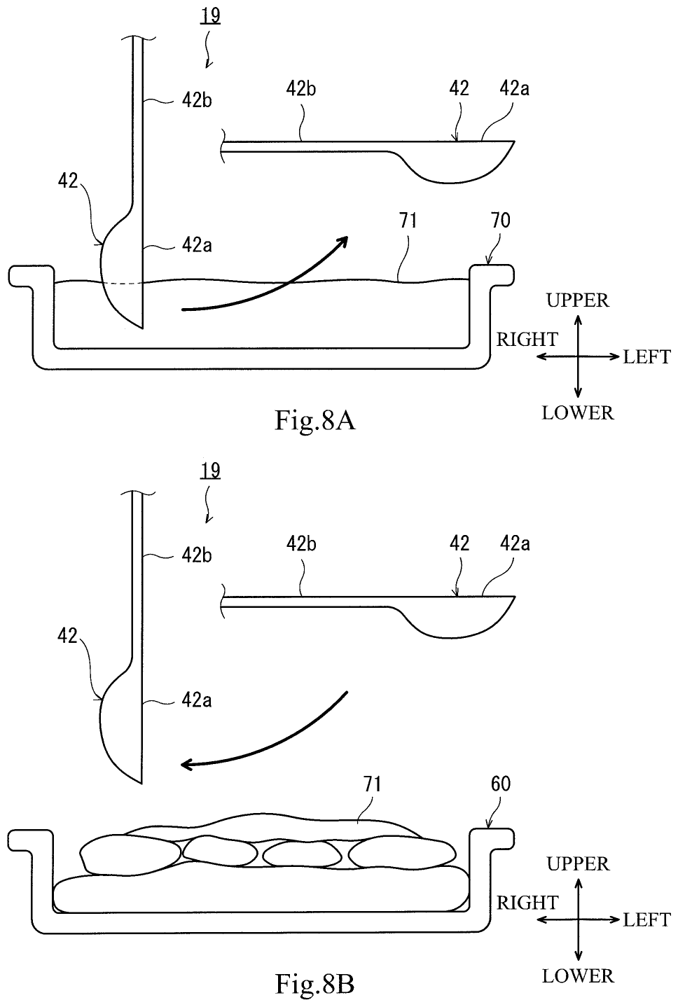

Next, the robot 11 conveys the food 60 to a predetermined position with the food 60 held by the end effector 18 (see Step S2 in FIG. 6). Specifically, the controller 14 controls the operation of the left arm 13 to convey the food 60 to a predetermined position in the vicinity of immediately above the container 70 for the sauce (71) of FIG. 1 with the side portion 60a of the food 60 held by the holding portions 31 and with the food 60 placed on the placing portion 32. In addition, the controller 14 controls the operation of the right arm 13 to sink part of the concave portion 42a in the sauce (71) filled in the container 70 while maintaining the tip end portion 42 of the end effector 19 in the reference state as shown in FIG. 8A. By normally rotating the rotational joint J5 of the tip end portion 42 in the reference state, part of the sauce (71) stored in the predetermined container 70 is held inside the concave portion 42a of the tip end portion 42.

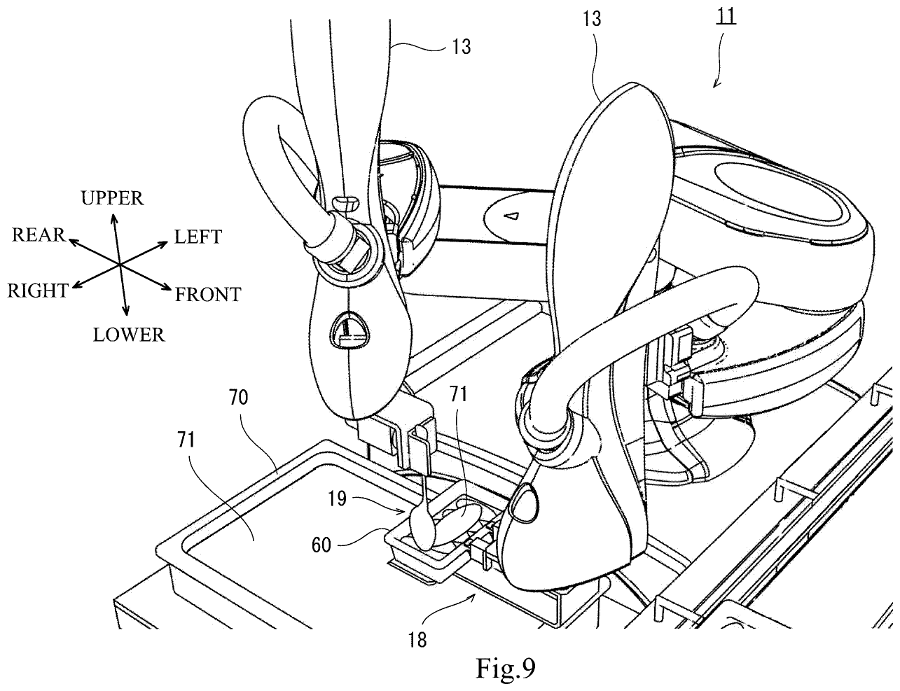

Next, the robot 11 performs predetermined work with respect to the food 60 by the end effector 19 (see Step S3 in FIG. 6). Specifically, as shown in FIG. 8B, the controller 14 makes the rotational joint J5 of the tip end portion 42 rotate reversely to release the sauce (71) held in the concave portion 42a of the tip end portion 42. By making the sauce (71) fall from the concave portion 42a, the sauce (71) can be uniformly supplied to the entire surface of the food 60 located at the position in the vicinity of immediately above the container 70 for the sauce (71) as shown in FIG. 9. Since a space above the food 60 held by the end effector 18 is secured, predetermined work (spreading of the sauce, for example) can be easily performed with respect to the food 60. As above, according to the present embodiment, the sauce (71) can be uniformly supplied to the entire surface of the food 60 by the simple operation of the end effector 19.

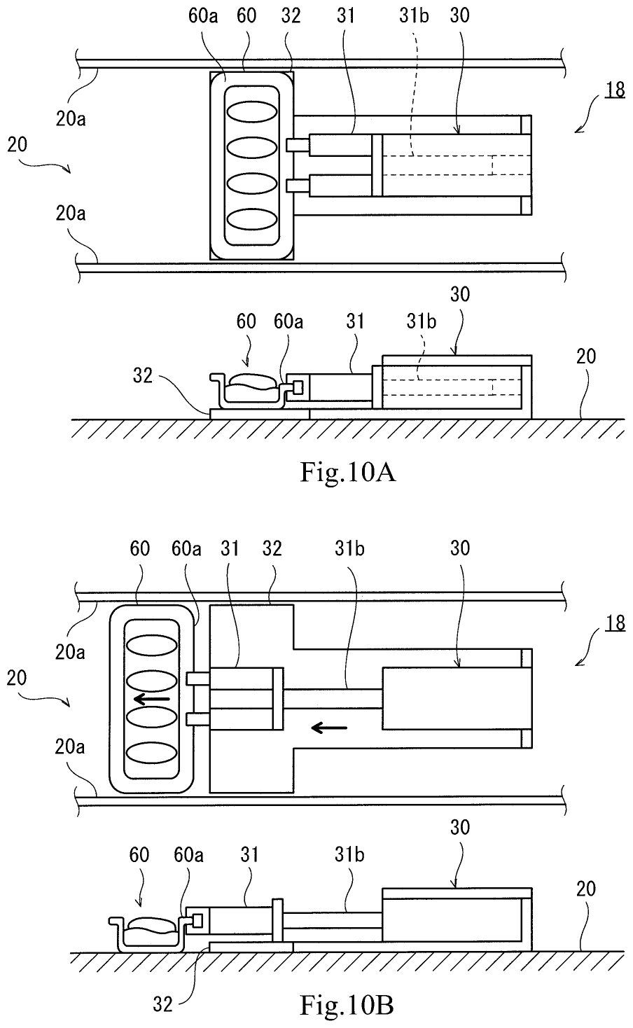

Next, the robot 11 releases the food 60 to a predetermined position on the conveyor 20 by the end effector 18 (see Step S4 in FIG. 6). Specifically, the controller 14 controls the operation of the left arm 13 to return the food 60, to which the sauce (71) is supplied, to a predetermined position on the conveyor 20 by moving the holding portions 31 in the front direction as shown in FIG. 10B with the side portion 60a of the food 60 held by the holding portions 31 of the end effector 18 and with the food 60 placed on the placing portion 32 as shown in FIG. 10A. Herein, the predetermined position denotes a position between the pair of regulating members 20a provided on the conveyor 20 so as to be opposed to each other. With this, the positioning of the holding portions 31 at the time of the releasing operation is only required to be performed regarding a position in the conveying direction of the conveyor 20 with respect to the food 60 arranged between the regulating members 20a. The robot 11 repeats the operations of Steps 51 to S4 till the end of the work (Step S5 in FIG. 6).

### OTHER EMBODIMENTS

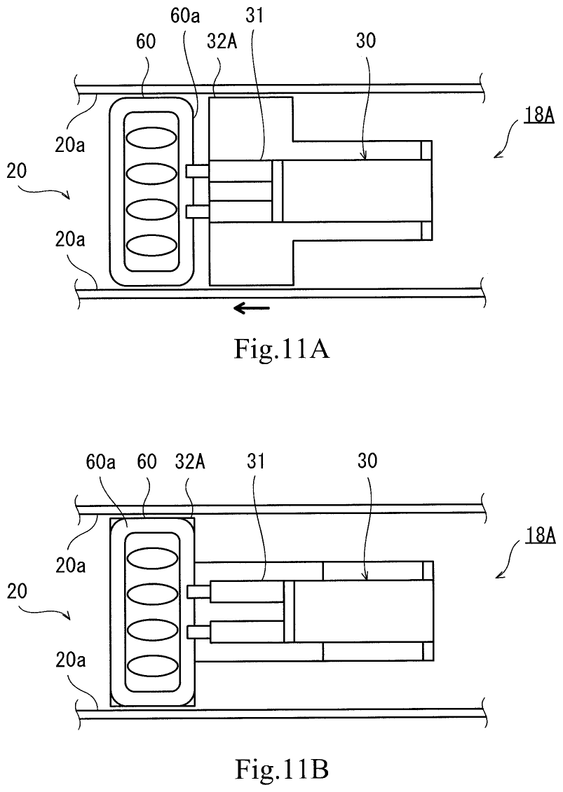

In the present embodiment, the placing portion 32 is fixed to the base portion 30, and in the holding operation (Step 51 in FIG. 6) of the food 60, the holding portions 31 are moved in the direction toward the base portion 30 with the food 60 held by the holding portions 31. With this, the food 60 is placed on the placing portion 32 (see FIGS. 7A and 7B). However, the placing portion 32 may be configured to be movable. FIGS. 11A and 11B are schematic diagrams each showing one example of the operation of the robot when the placing portion 32 is moved. In FIGS. 11A and 11B, a placing portion 32A is configured to be movable in the direction toward the base portion 30 and a direction opposite to the direction toward the base portion 30. As shown in FIG. 11A, the side portion 60a of the food 60 arranged at a predetermined position is held by the holding portions 31 of an end effector 18A. Then, as shown in FIG. 11B, with the food 60 held by the holding portions 31 of the end effector 18A, the placing portion 32A is moved in the direction opposite to the direction toward the base portion 30. With this, the food 60 is placed on the placing portion 32A. Since the food 60 remains held by the holding portions 31, a movement distance of the food 60 can be made short. Thus, the state of the content in the container for the food 60 is easily kept. As another example, the food 60 may be placed on the placing portion 32 by controlling both the movements of the holding portions 31 relative to the base portion 30 and the movement of the placing portion 32 relative to the base portion 30.

In the releasing operation (Step S4) of the food 60 in the present embodiment, the food 60 is returned onto the conveyor 20 (see FIGS. 10A and 10B) by moving the holding portions 31 in the front direction with the side portion 60a of the food 60 held by the holding portions 31 of the end effector 18 and with the food 60 placed on the placing portion 32. However, as shown in FIGS. 11A and 11B, the placing portion 32A may be configured to be movable. In this case, the food 60 may be released to a predetermined position by moving the placing portion 32A in the direction toward the base portion 30. Further, the food 60 may be released to the predetermined position by controlling both the movements of the holding portions 31 relative to the base portion 30 and the movement of the placing portion 32 relative to the base portion 30.

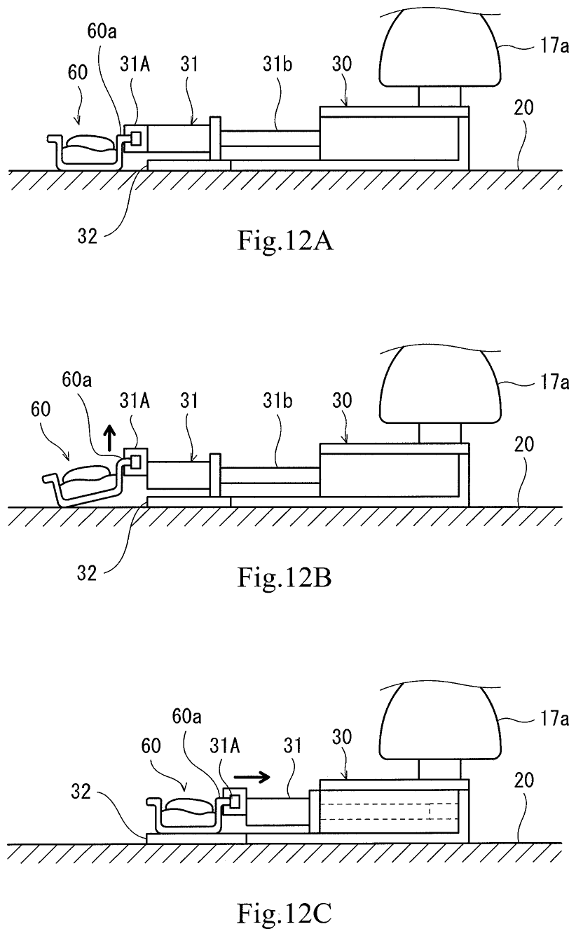

FIGS. 12A to 12C are schematic diagrams each showing another example of the holding operation of the food 60. In FIGS. 12A to 12C, jaw portions 31A of the holding portion 31 are configured to be movable in the upper-lower direction while holding the side portion 60a of the food 60. As shown in FIG. 12A, the side portion 60a of the food 60 is held by the jaw portions 31A of the holding portions 31. Then, as shown in FIG. 12B, with the side portion 60a of the food 60 held by the jaw portions 31A, the food 60 is slightly lifted upward. After the side portion 60a of the food 60 is slightly lifted, the food 60 is placed on the placing portion 32 by controlling the operation of the holding portions 31 as shown in FIG. 12C. Since the side portion 60a of the food 60 is slightly lifted upward, the food 60 is easily placed on the placing portion 32.

The above embodiment is configured such that the holding portions 31 of the end effector 18 hold the side portion 60a of the food 60 by changing the intervals each between the pair of jaw portions 31a (in the upper-lower direction in the drawings; see FIGS. 3A and 3B). However, the above embodiment is not limited to this configuration. For example, the above embodiment may be configured such that a side surface of the food 60 is held by being suctioned.

In the above embodiment, the food 60 is an in-flight meal. However, the food 60 may be other food, such as a box lunch, as long as the food is stored in a predetermined container. In the above embodiment, the ingredient 71 is sauce. However, the ingredient 71 may be liquid seasoning, such as dressing, or powdery seasoning, such as sesame seeds, as long as the ingredient is an ingredient stored in a predetermined container and having fluidity. Further, the ingredient may be soup, curry roux, or the like.

In the above embodiment, the double-arm type robot 11 is configured to perform work of conveying foods. However, the above embodiment may be realized by a dedicated apparatus including the end effectors 18 and 19 and capable of performing positioning control.

The robot 11 in the above embodiment is a horizontal articulated double-arm robot but may be a vertical articulated robot.

From the foregoing explanation, many modifications and other embodiments of the present invention are obvious to one skilled in the art. Therefore, the foregoing explanation should be interpreted only as an example and is provided for the purpose of teaching the best mode for carrying out the present invention to one skilled in the art. The structures and/or functional details may be substantially modified within the scope of the present invention.

### INDUSTRIAL APPLICABILITY

The present invention is useful at manufacturing sites for foods, such as in-flight meals and box lunches.

### REFERENCE SIGNS LIST

11 robot
13 robot arm
14 controller
18 end effector
19 end effector
19a base portion
19b tip end portion
20 conveyor
20a regulating member (conveyor)
30 base portion
31 holding portion
32 placing portion
40 base portion
41 rotary portion
42 tip end portion
42a concave portion
42b handle portion
60 food (in-flight meal)
60a side portion of food
70 container
71 ingredient (sauce)

1. A food holding apparatus configured to hold a food,
the food holding apparatus comprising:
a base portion;
a holding portion provided at the base portion and configured to hold a side portion of the food;
a placing portion provided at the base portion, the food being placed on the placing portion; and
a control portion configured to control a movement of the holding portion and a movement of the placing portion, wherein
with the side portion of the food held by the holding portion, the control portion controls at least one of the movement of the holding portion relative to the base portion and the movement of the placing portion relative to the base portion to place the food on the placing portion.

2. The food holding apparatus according to claim 1, wherein:
the holding portion is configured to be movable in a direction toward the base portion and a direction opposite to the direction toward the base portion;
the control portion makes the holding portion hold the side portion of the food arranged at a predetermined position; and
with the side portion of the food held by the holding portion, the control portion makes the holding portion move in the direction toward the base portion to place the food on the placing portion.

3. The food holding apparatus according to claim 1, wherein:
the placing portion is configured to be movable in a direction toward the base portion and a direction opposite to the direction toward the base portion;
the control portion makes the holding portion hold the side portion of the food arranged at a predetermined position; and
with the side portion of the food held by the holding portion, the control portion makes the placing portion move relative to the base portion in a direction toward the food to place the food on the placing portion.

4. The food holding apparatus according to claim 1, wherein with the side portion of the food held by the holding portion and with the food placed on the placing portion, the control portion controls at least one of the movement of the holding portion relative to the base portion and the movement of the placing portion relative to the base portion to release the food to a predetermined position.

5. The food holding apparatus according to claim 2, wherein:
the predetermined position is a position between a pair of regulating members provided on a conveyor so as to be opposed to each other; and
an interval between the pair of regulating members is slightly larger than a width of the food.

6. The food holding apparatus according to claim 1 wherein:
the holding portion is configured to be movable in an upper-lower direction while holding the side portion of the food; and
with the side portion of the food held by the holding portion, the control portion makes the holding portion slightly lift the food upward and then controls at least one of the movement of the holding portion relative to the base portion and the movement of the placing portion relative to the base portion.

7. A method of operating a food holding apparatus,
the food holding apparatus comprising:
a base portion;
a holding portion provided at the base portion and configured to hold a side surface of a food;
a placing portion provided at the base portion, the food being placed on the placing portion; and
a control portion configured to control a movement of the holding portion and a movement of the placing portion,
the method comprising
with the side surface of the food held by the holding portion, controlling at least one of the movement of the holding portion relative to the base portion and the movement of the placing portion relative to the base portion to place the food on the placing portion.

8. The food holding apparatus according to claim 2, wherein with the side portion of the food held by the holding portion and with the food placed on the placing portion, the control portion controls at least one of the movement of the holding portion relative to the base portion and the movement of the placing portion relative to the base portion to release the food to a predetermined position.

9. The food holding apparatus according to claim 3, wherein with the side portion of the food held by the holding portion and with the food placed on the placing portion, the control portion controls at least one of the movement of the holding portion relative to the base portion and the movement of the placing portion relative to the base portion to release the food to a predetermined position.

10. The food holding apparatus according to claim 3, wherein:
the predetermined position is a position between a pair of regulating members provided on a conveyor so as to be opposed to each other; and
an interval between the pair of regulating members is slightly larger than a width of the food.

11. The food holding apparatus according to claim 4, wherein:
the predetermined position is a position between a pair of regulating members provided on a conveyor so as to be opposed to each other; and
an interval between the pair of regulating members is slightly larger than a width of the food.

12. The food holding apparatus according to claim 2, wherein:
the holding portion is configured to be movable in an upper-lower direction while holding the side portion of the food; and
with the side portion of the food held by the holding portion, the control portion makes the holding portion slightly lift the food upward and then controls at least one of the movement of the holding portion relative to the base portion and the movement of the placing portion relative to the base portion.

13. The food holding apparatus according to claim 3, wherein:
the holding portion is configured to be movable in an upper-lower direction while holding the side portion of the food; and
with the side portion of the food held by the holding portion, the control portion makes the holding portion slightly lift the food upward and then controls at least one of the movement of the holding portion relative to the base portion and the movement of the placing portion relative to the base portion.

14. The food holding apparatus according to claim 4, wherein:
the holding portion is configured to be movable in an upper-lower direction while holding the side portion of the food; and
with the side portion of the food held by the holding portion, the control portion makes the holding portion slightly lift the food upward and then controls at least one of the movement of the holding portion relative to the base portion and the movement of the placing portion relative to the base portion.

15. The food holding apparatus according to claim 5, wherein:
the holding portion is configured to be movable in an upper-lower direction while holding the side portion of the food; and
with the side portion of the food held by the holding portion, the control portion makes the holding portion slightly lift the food upward and then controls at least one of the movement of the holding portion relative to the base portion and the movement of the placing portion relative to the base portion.
